(19) United States
(12) Patent Application Publication
(10) Pub. No.: US 2015/0270942 A1
(43) Pub. Date: Sep. 24, 2015

(54) METHODS AND SYSTEMS FOR MAINTAINING SPECTRAL COMPATIBILITY BETWEEN CO-EXISTING LEGACY AND WIDEBAND DSL SERVICES

(71) Applicant: IKANOS COMMUNICATIONS, INC., Fremont, CA (US)

(72) Inventors: Massimo SORBARA, Freehold, NJ (US); Julien Daniel PONS, Metuchen, NJ (US); Avadhani SHRIDHAR, Santa Clara, CA (US); Debajyoti PAL, Saratoga, CA (US)

(21) Appl. No.: 14/662,358

(22) Filed: Mar. 19, 2015

Related U.S. Application Data
(60) Provisional application No. 61/955,495, filed on Mar. 19, 2014.

(51) Int. Cl. H04L 5/14

(52) U.S. Cl. CPC H04L 5/14

(57) ABSTRACT

According to certain general aspects, the present invention relates to methods for transmitting signals on twisted wire-pairs above 30 MHz using frequency division duplexing (FDD) in support of 1 Gb/s aggregate services on short loop lengths while maintaining spectral compatibility with legacy ADSL2 (≦2.2 MHz bandwidth) and VDSL2 services (≦30 MHz bandwidth). An advantage of the FDD approach for Gb/s transmission according to the invention is spectral compatibility with legacy DSL services without the sacrifice of any capacity of the wider band.

### CROSS-REFERENCE TO RELATED APPLICATIONS

The present application claims priority to U.S. Prov. Appln. No. 61/955,495 filed Mar. 19, 2014, the contents of which are incorporated by reference herein in their entirety.

### FIELD OF THE INVENTION

The present invention relates generally to digital communications, and more particularly to methods and apparatuses for maintaining spectral compatibility with legacy DSL signals (e.g. 30 MHz VDSL2) in a wideband communications system.

### BACKGROUND OF THE INVENTION

Currently digital subscriber line (DSL) transmission is defined for operation up to 30 MHz of bandwidth based on ITU-T Recommendation G.993.2. In 2011, the ITU-T officially began a project to define advanced high speed transmission on twisted pair cables to address transmission on short loop lengths (<200 m) at speeds up to approximately 1 Gb/s aggregate (sum of upstream and downstream rates). The result of this study is a draft ITU-T Recommendation G.9701 (i.e. draft G.fast Recommendation or simply G.fast), the contents of which are incorporated by reference herein, which defines a transceiver specification based on time division duplexing (TDD) for the transmission of the downstream and upstream signals in a wide bandwidth of approximately 106 MHz using DMT modulation with 2048 subcarriers, and a symbol rate of 48 kHz (as a reference configuration). This contrasts with prior standards such as VDSL2 that has profile configurations 17 MHz (4096 DMT subcarriers in a bandwidth of approximately 17.6 MHz with a symbol rate of 4 kHz) and 30 MHz (4096 DMT subcarriers with a symbol rate of 8 kHz).

More particularly, according to the draft G.fast Recommendation, each TDD frame includes multiple symbols (e.g. 36 symbols), with some predefined symbol periods in each frame reserved for downstream communications (i.e. downstream symbol periods) and some other predefined symbol periods in the same frame reserved for upstream communications (i.e. upstream symbol periods). As a result, in any given symbol period, there will only be signals transmitted either in a downstream or upstream direction at a given time between the central office (CO) and customer premises equipment (CPE). This contrasts with FDD communications in which certain frequencies are reserved for downstream and other frequencies are reserved for upstream communications, where both downstream and upstream transmission occurs simultaneously in each direction using the appropriate reserved tones.

However, when migrating to the wider band (e.g. 106 MHz) services, challenges can arise where wideband TDD services such as proposed by G.fast are deployed in the same cable (albeit on different wire-pairs) with legacy FDD services such as VDSL. The challenge is in managing the interference between the two systems such that both legacy and wide band services can coexist in the same cable and minimize their impact on each other. There is currently no standard approach to solving such problems; hence service providers will need to provide a best practice in managing the coexistence.

### SUMMARY OF THE INVENTION

According to certain general aspects, the present invention relates to methods for performing wideband communications using signals of 106 MHz or more on twisted wire-pairs in a cable while maintaining spectral compatibility with legacy services such as ADSL2 (≦2.2 MHz bandwidth) and VDSL2 (≦30 MHz bandwidth) using wires in the same cable. An advantage of the approaches for Gb/s transmission according to the invention is spectral compatibility with legacy DSL services without the sacrifice of any bandwidth use of the wider band system.

In accordance with these and other aspects, a method for simultaneously performing xDSL communications and wideband communications above 30 MHz includes configuring the wideband communications to use frequency division duplexing (FDD), configuring the xDSL communications to use a first bandplan; and configuring the wideband communications to use a second bandplan that is spectrally compatible with the first band plan.

In further accordance with these and other aspects, a system for simultaneously performing xDSL communications and wideband communications above 30 MHz includes a first transceiver that is configured to perform wideband communications using frequency division duplexing (FDD); and a second transceiver that is configured to perform xDSL communications using a first bandplan, wherein the first transceiver is further configured to use a second band plan that is spectrally compatible with the first bandplan.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a block diagram illustrating an example system combining both legacy (e.g. 30 MHz VDSL2) and wideband (e.g. 106 MHz bandwidth) DSL services according to embodiments of the invention;

FIG. 2 is a diagram illustrating an example frequency band-plan according to embodiments of the invention;

FIG. 3 is a general PMS-TC frame structure for FDD operation according to embodiments of the invention;

FIG. 4 is a block diagram of an example PMS-TC reference model adapted from the draft G.fast Recommendation according to embodiments of the invention;

FIG. 5 is a block diagram of another example PMS-TC reference model adapted from VDSL2 G.993.2 according to embodiments of the invention;

FIG. 6 is a block diagram of an example TPS-TC reference model adapted from draft G.9701 according to embodiments of the invention;

FIG. 7 is a diagram illustrating Frequency Division Multiplexing of VDSL2 profile 30a with G.fast starting at 30 MHz; and

FIG. 8 is a block diagram for multiplexing baseband VDSL2 profile 30a with G.fast according to embodiments of the invention.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

As set forth above, time division duplexing (TDD) was chosen for G.fast over the traditional frequency division duplexing (FDD) that is used for DSL transmissions below 30 MHz. This was done mainly because it offers reduced complexity in design of the analog front end (i.e. analog-to-digital and digital-to-analog) electronics. However, the present inventors recognize that when TDD signals such as those used for G.fast and legacy FDD signals such as those used in VDSL are deployed in the same cable, near-end crosstalk is introduced in the frequency bands where the signals on different wire pairs are transmitting in opposite directions.

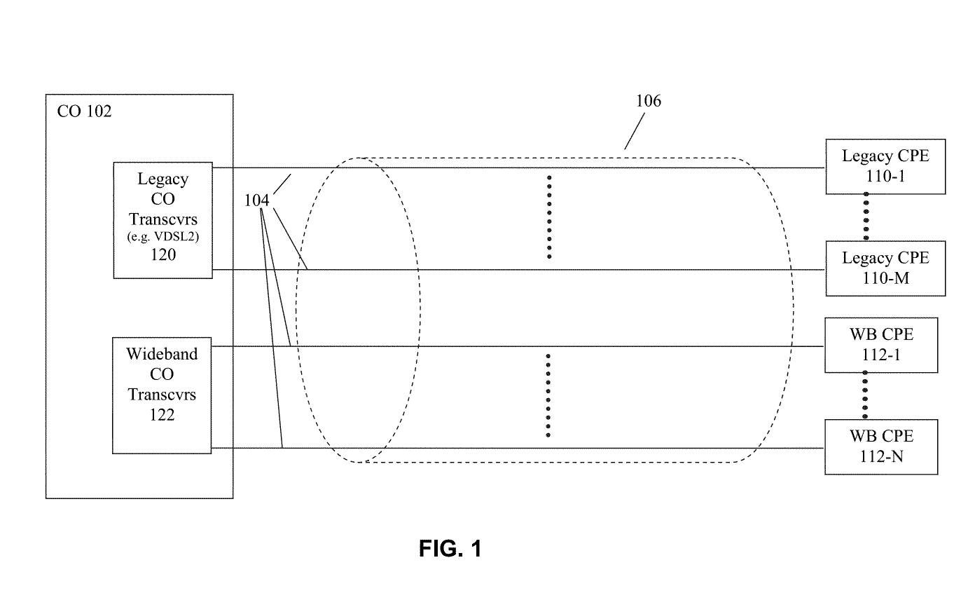

For example, as shown in FIG. 1, consider a cable 106 that includes wire pairs 104, certain of which wire pairs 104 are coupled between M legacy (e.g. 30 MHz VDSL2) CPE transceivers 110 and corresponding legacy CO transceivers (i.e. modems) 120 operating with FDD up to 30 MHz, while other pairs 104 are coupled between N wideband CPE transceivers 112 and wideband CO transceivers 122 operating, for example, up to 106 MHz or more (M and N are integers equal to or greater than one). If the wideband CPE transceivers 112 and CO transceivers 122 are operating using TDD communications starting at 2 MHz according to the current G.fast Recommendation, the cable 106 would suffer from near-end crosstalk (NEXT) in the overlapping frequency band from 2 to 30 MHz, which severely damages the signal quality in both of the services.

One possible approach for avoiding this spectral incompatibility, when mixing wideband TDD and legacy FDD signals in the same cable, is for the CO 102 to operate the transceivers 120 and 122 in the two different systems with non-overlapping frequency bands. For one example where the legacy service is VDSL2, the legacy VDSL2 transceivers 120 would be configured to operate at frequencies below 30 MHz and the wideband TDD transceivers 122 would be configured to operate only using frequencies above 30 MHz, rather than 2 MHz as allowed for in the G.fast Recommendation. Since the frequency bands of the two signals are not overlapping, their respective crosstalk will not interfere with each other; however, the TDD system operating above 30 MHz will have reduced capacity given the reduction in bandwidth compared to starting at 2.2 MHz for example.

More generally, for spectral compatibility between wideband services using TDD and legacy DSL services (collectively, xDSL) using FDD, namely ADSL2, ADSL2plus, and VDSL2, the following guidelines would be followed by the CO 102 to configure the wideband TDD operating bandwidth:

| Widest band Legacy DSL in the cable | TDD start frequency | |
|---|---|---|
| ADSL2 and ADSL2plus | ≧2.2 | MHz |
| VDSL2 profile 17a | ≧17.6 | MHz |
| VDSL2 profile 30a | ≧30 | MHz |

A problem with this approach is that this forces the wideband transceivers to lose the capacity available with the frequencies of the legacy DSL, which sacrifices performance that would otherwise be possible.

According to aspects of the invention, another approach is to use FDD for the wideband services as well as other legacy DSL services when such different services use wires in the same cable. The present inventors recognize that with frequency division duplexing, the wideband FDD system may reside in the same cable as legacy DSL provided that the band plan in the legacy DSL frequency band (e.g. VDSL) is the same for all the signals in the cable.

According to one aspect of the invention, therefore, for implementation of high speed (i.e. signals with bandwidth greater than 30 MHz) FDD transmission on twisted wire-pairs, a governing band that applies to both legacy and wideband services is used. The present inventors recognize that ITU-T Recommendation G.993.2 Annexes A, B, and C already define numerous frequency band plans based on regional deployment requirements. In embodiments, therefore, such defined band plans are extended for use with wideband services.

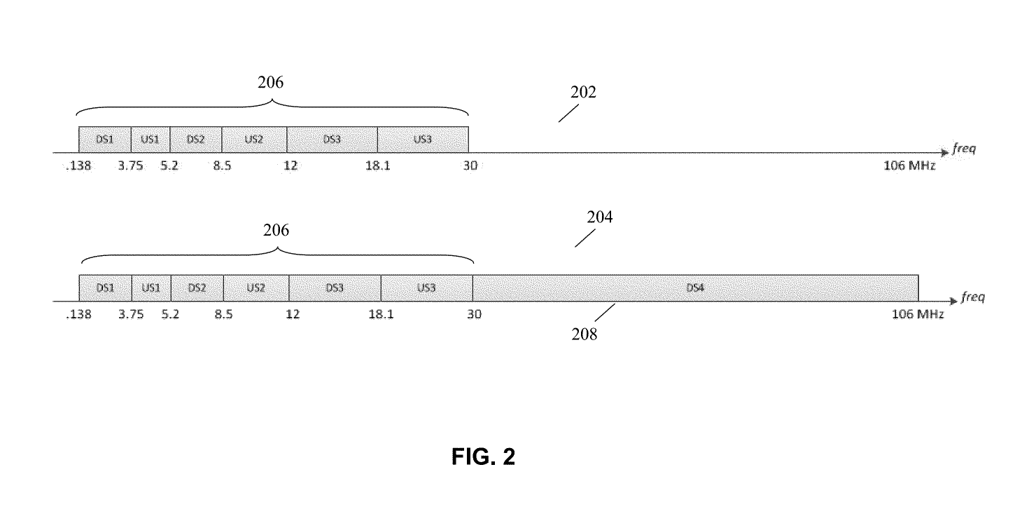

As an example such as that shown in FIG. 2, embodiments of the invention wherein the legacy DSL system is VDSL2 use the frequency plan 202, which is profile 30a defined in Annex C of G.993.2 for frequencies below 30 MHz. As can be seen, plan 202 includes three downstream bands (or sub-bands) DS1, DS2 and DS3 and three upstream bands US1, US2 and US3 (collectively shown as 206). Meanwhile, the wideband DSL system uses band plan 204. As can be seen, band plan 204 has three upstream and downstream bands below 30 MHz (also collectively shown as 206) that are exactly the same as the bands in plan 202. However, band plan 204 further includes a higher frequency band 208 from 30 to 106 MHz which is used exclusively for downstream transmission (i.e. DS4). This band plan will be used as the driving example in the present specification; however, the invention is not limited to this example. Those skilled in the art will understand how to implement the invention with other band plans and/or other legacy DSL systems after being taught by this example. Moreover, those skilled in the art will understand how to implement the invention when more than one type of legacy DSL system uses the same cable as a wideband system. Still further, it should be apparent that wideband frequencies above the highest legacy frequency can include both upstream and downstream bands, and/or that higher frequencies above 106 MHz are possible.

According to embodiments of the invention, in operation of a system such as that shown in FIG. 1, and using a band plan such as that shown in FIG. 2, legacy CPE transceivers 110 and CO transceivers 120 will perform FDD communications using the band plan 202 for frequencies between 0.138 MHz and 30 MHz, while wideband CPE transceivers 112 and CO transceivers 122 will perform FDD communications using the band plan 204 for all frequencies between 0.138 MHz and 106 MHz. With this FDD configuration, the two systems are all spectrally compatible with each other.

It should be noted that legacy CPE transceivers 110 and CO transceivers 120 include DSL transceivers having conventional processors, chipsets, firmware, software, etc. that implement legacy FDD communication services such as those defined by VDSL2, ADSL2, etc. using a band plan such as 202 and further details thereof will be omitted here for sake of clarity of the invention.

Meanwhile, according to aspects of the invention, wideband transceivers 112 and CO transceivers 122 include DSL transceivers having processors, chipsets, firmware, software, etc. that implement wideband FDD communication services up to 106 MHz, for example, and using a band plan 204 such as that shown in FIG. 2. As set forth above, this contrasts with the TDD approach defined by the currently proposed G.fast standard. Accordingly, such processors, chipsets, firmware, etc. are adapted with wideband FDD functionalities in addition to, or alternatively to, the TDD functionalities defined by the currently proposed G.fast standard. Those skilled in the art will be able to understand how to adapt such processors, chipsets, firmware, software, etc. to implement such wideband FDD functionalities after being taught by the above and following examples.

It should be noted that legacy CO transceivers 120 and wideband CO transceivers 122 are shown separately for ease of illustration, it is possible that the same CO transceivers can include functionality for communicating both with legacy CPE transceivers 110 and wideband CPE transceivers 112. The wideband transceivers may also be designed to allow fallback operation to the legacy transceivers.

Example embodiments of wideband CPE transceivers 112 and CO transceivers 122 operating with FDD according to aspects of the invention may be implemented by adopting aspects of the draft G.fast specification and applying appropriate modifications to the framing and modulation parameters as necessary to operate with FDD instead of TDD. In alternative embodiments of the invention, they may be implemented by extending VDSL2 with appropriate modifications to accommodate the extended bandwidth for achieving wideband FDD operations greater than 1 Gb/s aggregate transmission. Both possible embodiments will be described in more detail below.

The present inventors have performed feasibility studies that have shown that 100 MHz of operating bandwidth is sufficient to achieve 1 Gb/s aggregate transmission at frequencies starting from 17 MHz. By starting transmissions as low as 2.2 MHz as specified in the draft G.fast Recommendation there is additional available capacity beyond 1 Gb/s transmission. Based on this study, the physical medium dependent (PMD) operating parameters selected for construction of the DMT symbols for use in wideband FDD services according to some embodiments of the invention (similar to those specified in section 10.4 of the draft G.fast Recommendation) are the following:
Tone Spacing: Δf=51.75 kHz (six times the tone spacing of VDSL2 profile 30a that is 8.625 kHz)
Number of Tones: N=2048
Reference Sample Rate: 2NΔf=211.968 MHz
CE length=320 samples (windowing)
DMT Symbol Rate fDMT=[2N/(2N+L_{CE})]×Δf=48 kSym/s (20.83 is DMT symbol period)
Windowing (β)=64 or 128 samples

Based on the above DMT symbol structure, transceivers 112 and 122 according to embodiments of the invention use a 6 ms super-frame structure as a reference (or default) configuration (similar to the super-frame structure specified in section 10.6 of the draft G.fast Recommendation). The superframe defines a frame boundary using a sync symbol as the frame boundary demarcation; this sync symbol is also used to modulate the bits of a pilot sequence to support operation with vectoring and also serves as the synchronization control element for managing transceiver parameter changes with online reconfiguration.

In additional or alternative embodiments, to facilitate separation of the upstream and downstream directions of transmission with FDD according to aspects of the invention, digital duplexing is performed in transceivers 112 and 122 with the use of windowing as per G.993.2 section 10.4.4. Digital duplexing combines the use of windowing and timing advance to properly align the transmitted and received DMT symbols so as to isolate the upstream and downstream signal spectra without the use of analog filtering.

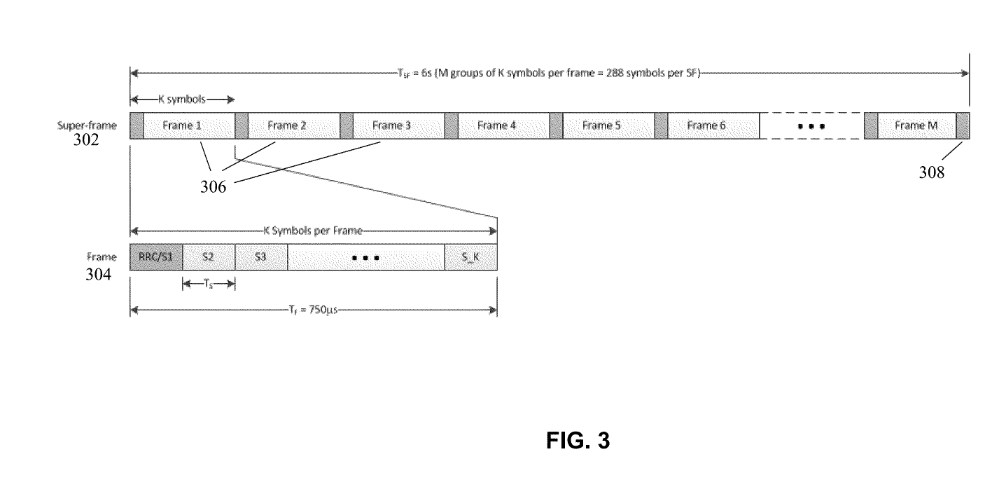

FIG. 3 is a diagram illustrating an example generalized PMS-TC frame structure for use with FDD operation according to embodiments of the invention and consistent with the DMT and frame parameters described above. According to aspects of the invention, this example structure adapts multiplexing of the robust management channel (RMC) derived from the draft G.fast Recommendation, which are described in more detail below. As shown in FIG. 3, each superframe 302 contains M frames, and each frame 304 contains K DMT symbols. Unlike the TDD frames of the draft G.fast recommendation, each of the K DMT symbols is constructed by transceivers 112 and 122 for both downstream and upstream data using respective sets of tones specified in the band plan such as band plan 204 in FIG. 2. In each of the upstream and downstream directions, the first symbol 306 in each frame contains the RMC channel implemented on a subset of the respective downstream and upstream tones and the remaining tones in the symbol carry the end user data. The RMC symbol carries a retransmission return channel (RRC) within the dedicated tones in this symbol only, where the dedicated tones are provisioned with higher margin and lower bit loads; the remaining set of tones in the RMC symbol carry end user data. Each DMT symbol has a duration of T_{S}=1/48 kHz=20.83 μsec. For the default 6 ms superframe, there are 288 DMT symbols in the superframe.

Per the example shown in in FIG. 3, the sync symbol 308 is the last DMT symbol in the superframe. If 36 DMT symbol periods are allocated per frame, then there are M=8 frames per superframe, where each frame period is 750 μs. The PMS-TC frame parameters M and K may be configured commensurate with the application being supported. For example, K=36 symbol periods of (1/48 kHz) defines a frame interval of 750 μsec, and M=8 groups of frames provides a superframe period of 6 ms. The superframe duration period TSF is determined by the parameters M and K as T_{SF}=M*K*T_{S}.

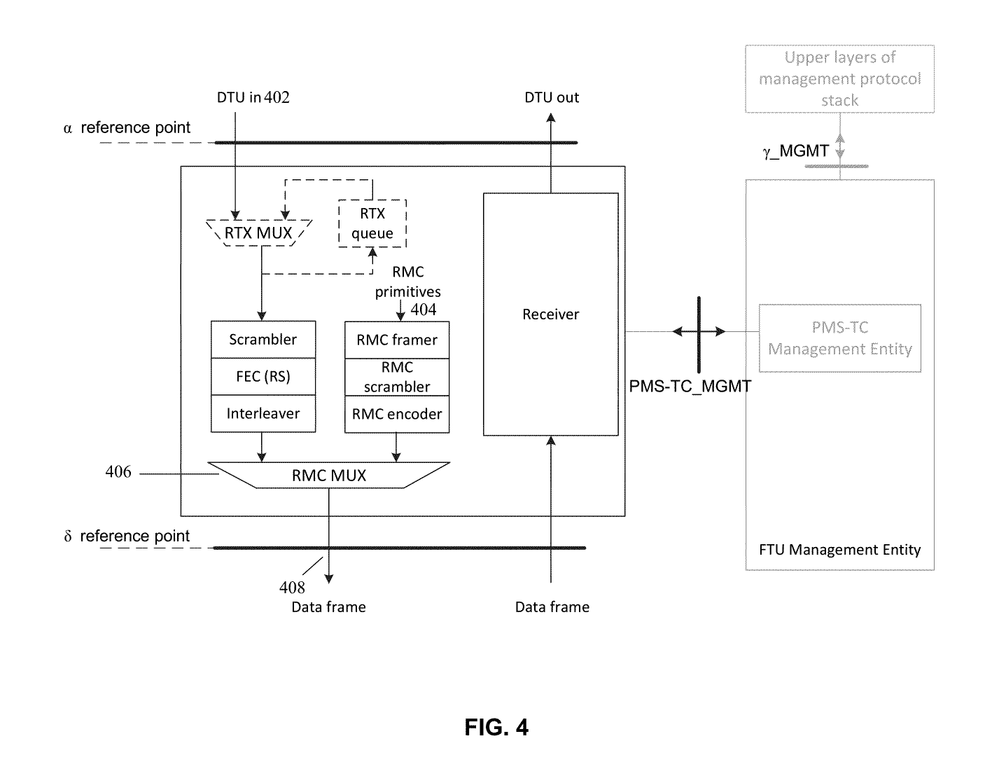

FIG. 4 is a block diagram illustrating an example functional reference model of the physical medium specific transmission convergence (PMS-TC) layer immediately above the PMD layer according to embodiments of the invention. This example embodiment implements a model that is similar to the model defined in the draft G.9701 (G.fast) Recommendation, and those skilled in the art will be able to understand how to adapt this model for use in transceivers 112 and 122 after being taught by the present disclosure. This layer defines the framing for the multiplexing of the end user data with management data to obtain a frame and superframe structure such as that shown in FIG. 3. The end user data is a flow of data transmission units (DTUs) 402 from the layer immediately above the PMS-TC. As shown in FIG. 3, the first symbol in each frame 304 is defined as the RMC symbol. In the draft G.fast Recommendation, the management data 404 in the RMC is sent on specific pre-assigned tones within this symbol. In the RMC symbol, the RMC data is time division multiplexed by mux 406 together with end-user data to form a continuous flow of data bytes 408 to the PMD layer. The bit loadings on the tones for the RMC channel are typically lower in level such that higher signal-to-noise ratio margin is allocated to provide higher noise immunity than allowed for the end-user data. The remaining symbols in each frame only carry end-user data and so the bit loading are provided according to margin assigned for the end-user data. The RMC channel carries acknowledgements for the received DTUs and other management data associated for this level of framing.

It is noted that the RMC channel has the primary responsibility of providing the acknowledgement responses in support of retransmission of DTUs in the main data path. Also, commands for support of fast rate adaption and framer maintenance are communicated through the RMC.

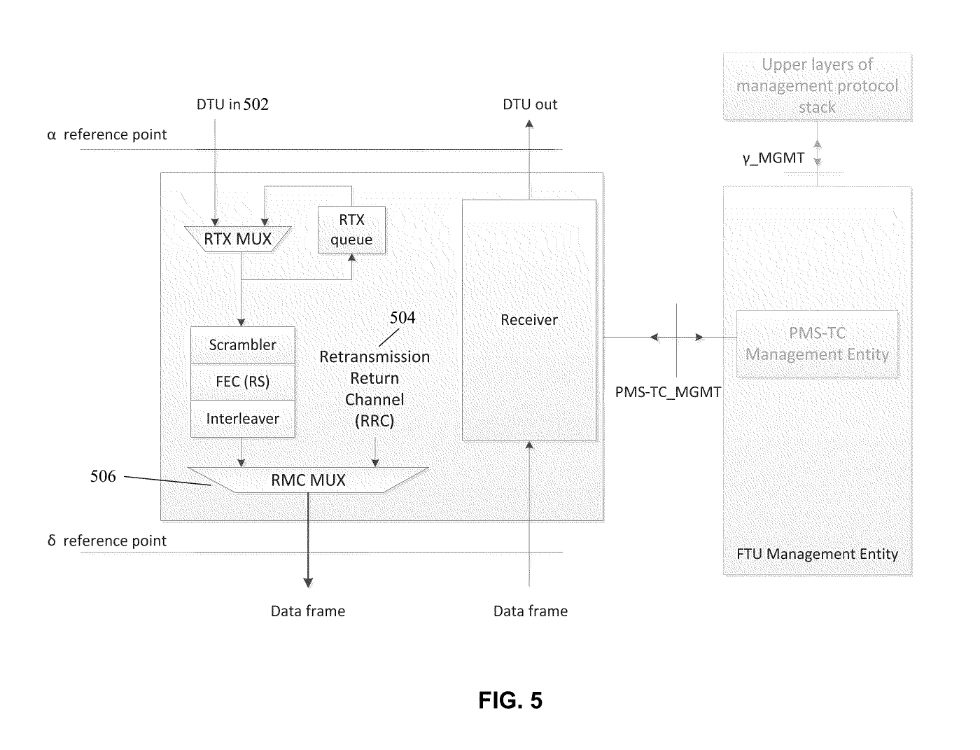

An alternative to adapting the PMS-TC frame structure defined by the draft G.fast Recommendation in the embodiment described above is to adapt legacy PMS-TC models such as that defined by VDSL2 G.993.2 as shown in FIG. 5.

As shown in FIG. 5, in this example embodiment, transceivers 112 and 122 include a mux 506 to multiplex the management data 504 in the PMS-TC as a separate latency path. Implementation of the latency path for the Retransmission Return Channel (RRC) may follow the same rules as defined for VDSL2 in G.993.2 and G.998.4. It should be noted that the framing of G.993.2 also multiplexes an embedded operations channel (not shown in the figure); this multiplexing may be done in the main data channel path 502 and/or the latency path 504 supporting the retransmission return channel.

The layer above the PMS-TC is the Transport Protocol Specific Transmission Convergence (TPS-TC) layer. The TPS-TC layer collects the end user and other functional and management data from the layer 2 transmit data buffers and formulates data blocks 502 for transmission to the PMS-TC layer below.

According to embodiments of the invention adapting legacy PMS-TC models, implementation of the TPS-TC layer for FDD operation in transceivers 112 and 122 may be derived either from the draft G.9701 Recommendation, or from the VDSL2 G.993.2 Recommendation shown in FIG. 5.

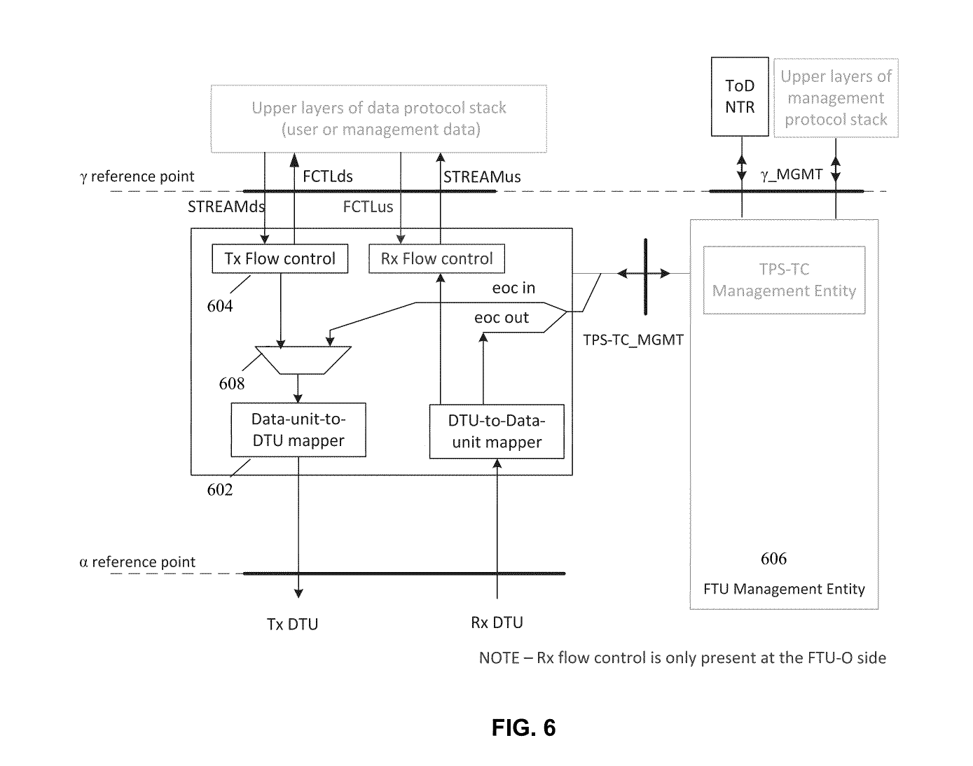

FIG. 6 shows an alternative embodiment to that shown in FIG. 5 in which transceivers 112 and 122 implement the functional reference model of the TPS-TC from the draft G.9701 Recommendation. As shown in FIG. 6, in the draft G.9701 Recommendation (e.g. section 8) as adapted for use in embodiments of the invention, data units are mapped to data transmission units by mapper 602 in the TPS-TC layer. The units of data are the payload elements of the DTUs, and consist of sub-frame blocks of end user data from upper protocol layers via a Tx flow control unit 604 multiplexed by mux 608 together with sub-frame blocks of management data, including an embedded operations channel (eoc) from a FTU management entity 606.

Although not illustrated, in the G.993.2 implementation of TPS-TC as adapted in embodiments of the invention, 64/65-octet encapsulation of the end-user data for transmission to the PMS-TC layer is performed. A prime difference between the TPS-TC operation of draft G.9701 Recommendation shown in FIG. 6 and the G.993.2 approach is that the eoc is multiplexed with end user data in the TPS-TC layer for the draft G.9701 Recommendation implementation. Meanwhile, in the G.993.2 approach, the TPS-TC layer transports only end user data and the eoc is multiplexed in the PMS-TC layer.

To summarize, the foregoing descriptions provide different possible approaches to maintaining spectral compatibility while operating both legacy and wideband services using the same cable. In a first possible approach, the wideband services are operated using TDD frames only as defined by G.fast, but with a starting frequency beginning above the highest legacy DSL service used in the cable. In the embodiments described above in connection with FIGS. 4 to 6, example approaches for providing wideband services include either adapting G.fast or legacy PMS-TC layer reference models for forming FDD frames only such as that shown in FIG. 3 and FDD symbols having tones spanning the entire usable wideband spectrum as shown in FIG. 2.

Yet another possible alternative for implementation of wideband services that still maintains spectral compatibility with legacy DSL services is to operate a legacy DSL channel using FDD and having a band plan the same as the legacy services in the same cable and a G.fast channel using TDD per draft G.9701 operating with a start frequency above the highest legacy frequency. The transceivers 112 and 122 frequency division multiplex the G.fast spectrum to reside above the underlying legacy DSL. In this example implementation, the total bit rates may be combined with the use of Ethernet Bonding (such as defined by G.998.2) of the legacy DSL and G.fast channels to obtain bit rates similar to those possible in the previous embodiments.

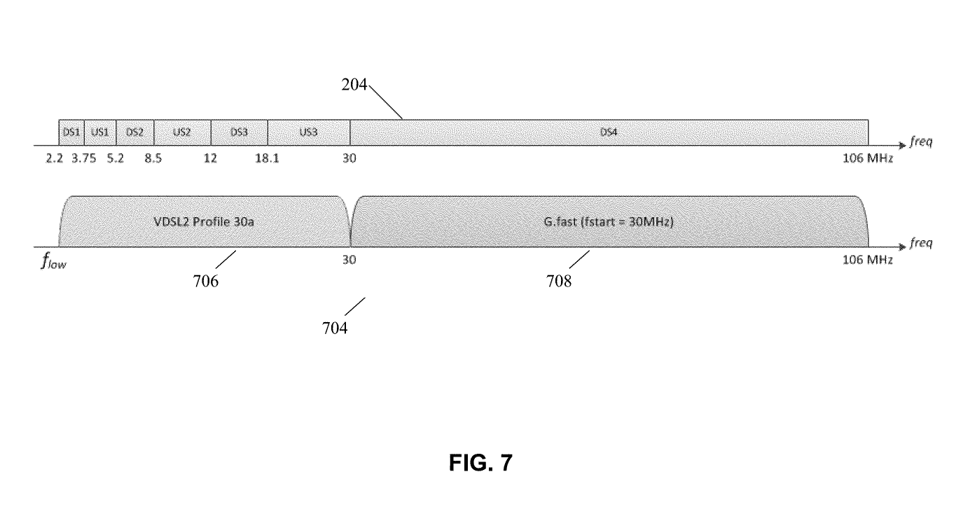

For example, FIG. 7 shows the band plan 204 used for providing wideband services in the embodiments described above. Band plan 704 is used in these alternative embodiments in an example where the legacy DSL services operating in the same cable are VDSL2. As shown in this example, band plan 704 includes the baseband VDSL2 profile 30a using the frequency band plan 706 of G.993.2 Annex C at frequencies below 30 MHz and the G.fast spectrum 708 of G.9701 using a start frequency ≧30 MHz. Those skilled in the art will recognize how band plan 704 and these alternative embodiments can be adapted for use with other legacy DSL services.

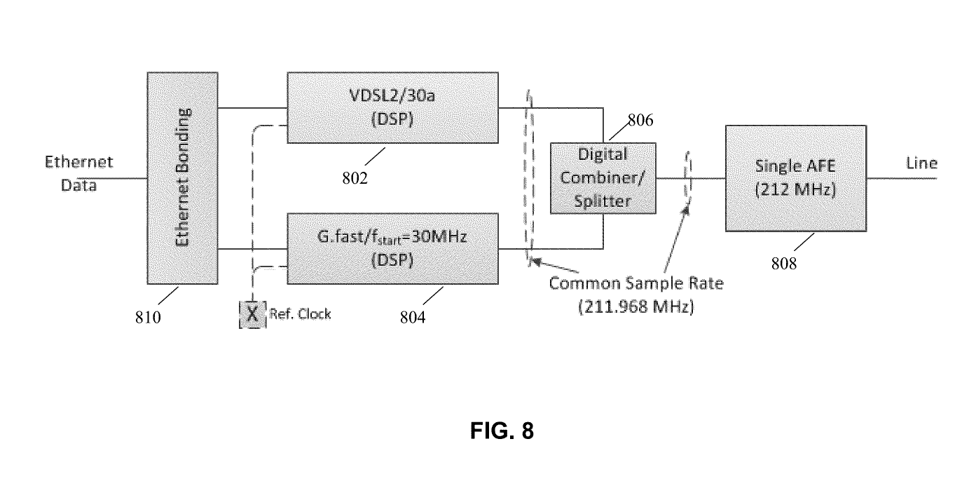

FIG. 8 is an example block diagram of circuitry in transceivers 112 and 122 that implements wideband services according to these alternative embodiments of the invention and the example band plan 704 shown in FIG. 7.

As shown, transceivers 112 and 122 include DSPs 802 and 804 respectively providing a legacy VDSL2 channel operating up to 30 MHz and a G.fast channel starting at 30 MHz. Digital combiner 806 combines the two spectra 706 and 708 respectively in the transmit path before AFE 808 and splits the spectra 706 and 708 in the receive path after AFE 810. As shown, the AFE 808, VDSL2 channel and G.fast channel all use a common sample rate of 211.968 MHz in accordance with the maximum frequency defined by the current draft G.fast Recommendation. As further shown, transceivers 112 and 112 include Ethernet bonding module 810 to combine the bit rates of the two frequency channels into one Ethernet bit stream in the receive path and split the Ethernet bit stream into two channels in the transmit path. Those skilled in the art of Ethernet bonding in connection with DSL will be able to understand how to implement transceivers 112 and 122 such as that shown in FIG. 8 after being taught by the present examples.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. A method for simultaneously performing xDSL communications and wideband communications above 30 MHz, comprising:
configuring the wideband communications to use frequency division duplexing (FDD);
configuring the xDSL communications to use a first bandplan; and
configuring the wideband communications to use a second band plan that is spectrally compatible with the first bandplan.

2. A method according to claim 1, wherein the xDSL communications are ADSL2.

3. A method according to claim 1, wherein the xDSL communications are VDSL2.

4. A method according to claim 1, wherein the xDSL communications and the wideband communications are performed using lines in a common cable.

5. A method according to claim 1, wherein the wideband communications use a bandwidth of at least 106 MHz.

6. A method according to claim 1, further comprising configuring the wideband communications to perform digital duplexing to facilitate separation of upstream and downstream portions of the second band plan.

7. A method according to claim 1, further comprising configuring the wideband communications to use a frame structure that includes retransmission control information in each frame.

8. A method according to claim 1, further comprising configuring the wideband communications to use a separate latency path for retransmission control information.

9. A system for simultaneously performing xDSL communications and wideband communications above 30 MHz, comprising:
a first transceiver that is configured to perform wideband communications using frequency division duplexing (FDD); and
a second transceiver that is configured to perform xDSL communications using a first bandplan,
wherein the first transceiver is further configured to use a second bandplan that is spectrally compatible with the first bandplan.

10. A system according to claim 9, wherein the xDSL communications are ADSL2.

11. A system according to claim 9, wherein the xDSL communications are VDSL2.

12. A system according to claim 9, wherein the first and second transceivers are both connected to lines in a common cable.

13. A system according to claim 9, wherein the wideband communications use a bandwidth of at least 106 MHz.

14. A system according to claim 9, wherein the first transceiver is further configured to perform digital duplexing to facilitate separation of upstream and downstream portions of the second bandplan.

15. A system according to claim 9, wherein the first transceiver is further configured to use a frame structure that includes retransmission control information in each frame.

16. A system according to claim 9, wherein the first transceiver is further configured to use a separate latency path for retransmission control information.

17. A system for simultaneously performing xDSL communications and wideband communications above 30 MHz, comprising:
a first transceiver that is configured to perform wideband communications using time division duplexing (TDD) and a first bandplan;
a second transceiver that is configured to perform xDSL communications using frequency division duplexing (FDD) and a second bandplan; and
an Ethernet bonding module to combine data received by the first and second transceivers into a common Ethernet bit stream,
wherein the first bandplan is spectrally separate from the second bandplan.

18. A system according to claim 17, wherein the xDSL communications are ADSL2.

19. A system according to claim 17, wherein the xDSL communications are VDSL2.

20. A system according to claim 17, wherein the first and second transceivers are both connected to lines in a common cable.

21. A system according to claim 17, wherein the wideband communications use a bandwidth of at least 106 MHz.
